(19) United States
(12) Patent Application Publication
(10) Pub. No.: US 2015/0158707 A1
(43) Pub. Date: Jun. 11, 2015

(54) Hose Header For A Lift Truck Mast

(71) Applicant: NACCO Materials Handling Group, Inc., Fairview, OR (US)

(72) Inventors: Joseph A. Brotherton, Portland, OR (US); James Nielson, Portland, OR (US); Dennis Loewen, Vancouver, WA (US)

(73) Assignee: NACCO MATERIALS HANDLING GROUP, INC., Fairview, OR (US)

(21) Appl. No.: 14/565,886

(22) Filed: Dec. 10, 2014

Related U.S. Application Data
(60) Provisional application No. 61/914,747, filed on Dec. 11, 2013.

(51) Int. Cl. B66F 9/20; B66F 9/08

(52) U.S. Cl. CPC B66F 9/205; B66F 9/08

(57) ABSTRACT

A hose header for a lift truck mast is constructed to inhibit wear of hydraulic hoses.

### TECHNICAL FIELD

The present invention relates to lift trucks, and particularly to masts for lift trucks.

### SUMMARY

A hose header for a lift truck mast is constructed to inhibit wear of hydraulic hoses.

### BRIEF DESCRIPTION OF THE DRAWINGS

FIG. 1 illustrates a rear view of a mast with a hose header.

FIG. 2 illustrates an enlarged front left isometric view of the hose header of FIG. 1.

FIG. 3 illustrates a right side view of the hose header of FIG. 2.

FIG. 4A illustrates a cross-sectional schematic view of a hypothetical roller arrangement configured along a circular arc.

FIG. 4B illustrates a cross-sectional schematic view of a hypothetical roller arrangement configured along an elliptical arc.

FIG. 4C illustrates a hypothetical plot of forces acting on the hypothetical roller arrangement of FIG. 4A as the height Z of roller 75A varies above the rollers 75.

FIG. 5 illustrates a right side view of another hose header.

FIG. 6 illustrates an enlarged view of an optional hose guard and of a hose roller.

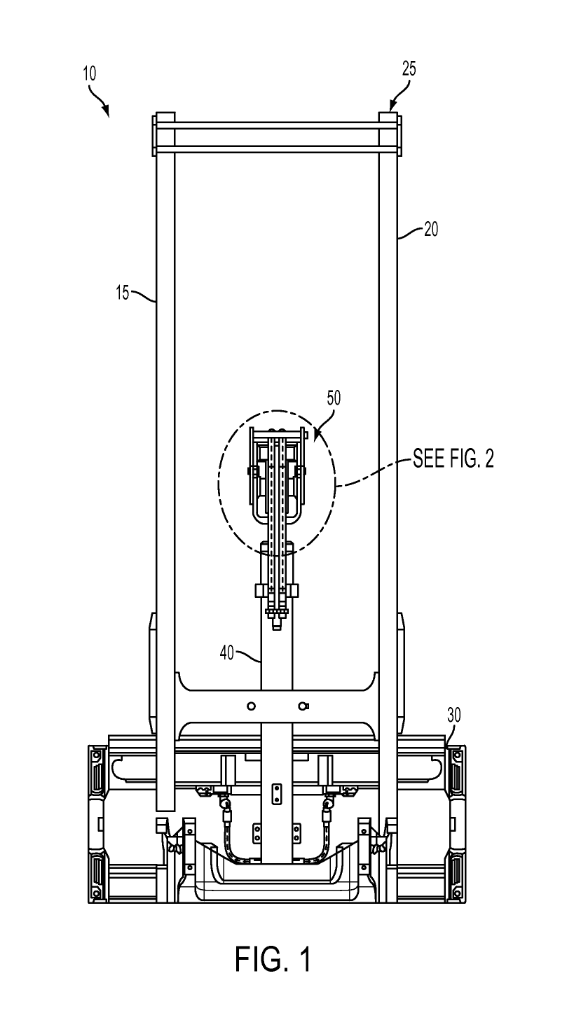

### DETAILED DESCRIPTION

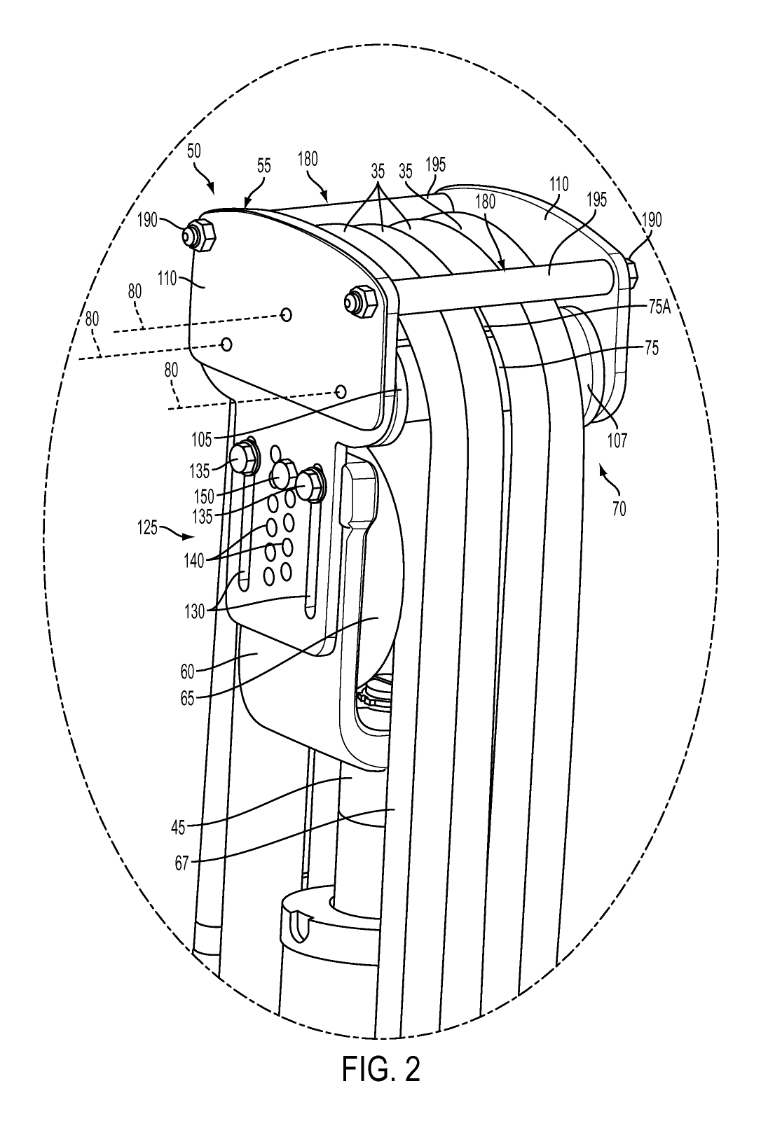

A mast assembly 10 comprises a first upright 15 and a second upright 20 that form a rail 25, and a carriage 30. A suitable load engaging attachment (not illustrated), such as a fork assembly, hydraulic side shifter, rotators, push/pull, carton clamp, paper roll clamp, bale clamp, and etc., may be secured to the carriage 30. Hydraulic hoses 35 (FIG. 2) are required for operation of the hydraulic cylinder 40 that raises and lowers the carriage 30 and for operation of various load engaging attachments, such as hydraulic side shifter, rotators, push/pulls, carton clamps, paper roll clamps, bale clamps, and etc. While a single stage mast 10 is illustrated, the invention is not limited to use with single stage masts, but may be used with multi-stage masts as well.

Hydraulic cylinder 40 moves the carriage 30 vertically along the rail 25 as is well understood in the art. The piston end 45 (FIG. 2) moves vertically relative to the hydraulic cylinder 40, and carries a hose header 50 with it.

When the piston end 45 moves upward or downward, the carriage 30 and the hose header 50 elevate, or descend, along the rail 25 thus causing the hoses 35 to move over the hose header 50. As described below, the hose header 50 is constructed to inhibit wear on the hoses 35 when the piston end 45 moves upward and downward.

With reference to FIG. 2, hose header 50 comprises an upper portion 55 and a lower portion 60. A chain sheave 65 is preferably rotatingly secured to the lower portion 60 for carrying lift chains 67 associated with the carriage 30. A hose roller assembly 70 is preferably secured to the upper portion 55 to facilitate moving hoses 35 over the hose header 50 while inhibiting wear to the hoses 35 caused by vertical motion of the hose header 50.

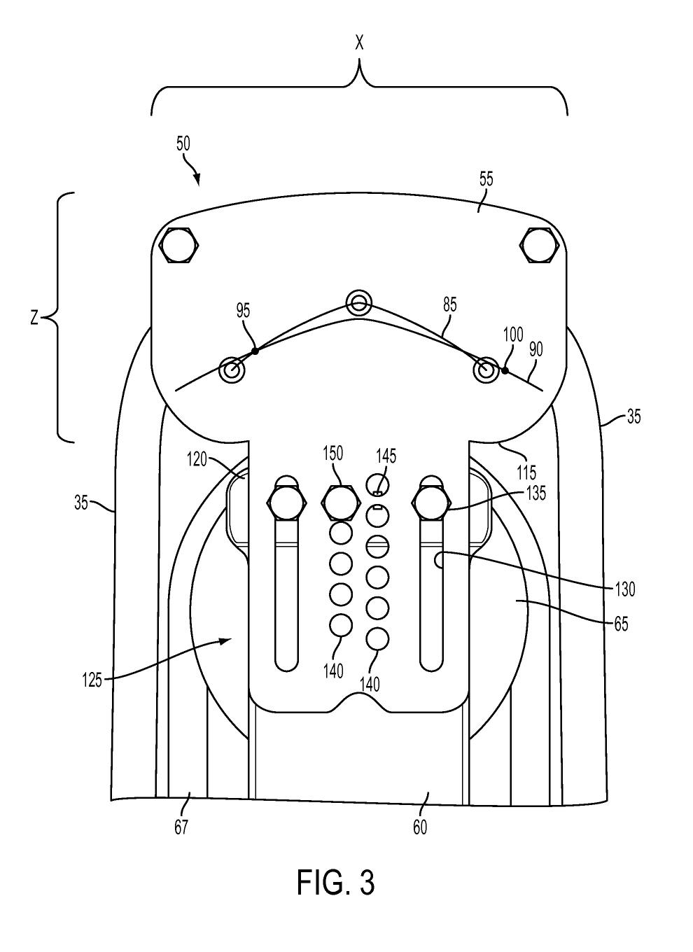

In the illustrated embodiment, the hose roller assembly 70 comprises two hose rollers 75 and one hose roller 75A that each have a longitudinal axis 80 that intersects a point along an elliptical arc 85 (FIG. 3). The hose rollers 75 and 75A are preferably arranged along an elliptical arc 85 to inhibit point stress resulting from contact between the hoses 35 and the hose rollers 75 and 75A. The present inventors have recognized several novel advantages associated with arranging the longitudinal axes of the hose rollers 75 and 75A along an elliptical path. One advantage is that arranging rollers along a circular arc typically induces higher levels of stress in hoses due to the relatively small surface area of contact between the hoses and rollers and the relatively tight curvature of the hoses as they pass over the apex of the circular arc. In contrast, arranging hose rollers 75 and 75A along an elliptical path creates an elliptical hose path that results in lower stresses in hoses 35, at least partially due to the relatively large surface area of contact between the hoses 35 and rollers 75 and 75A and the relatively relaxed curvature of the hoses 35 as they pass over the apex of the ellipse.

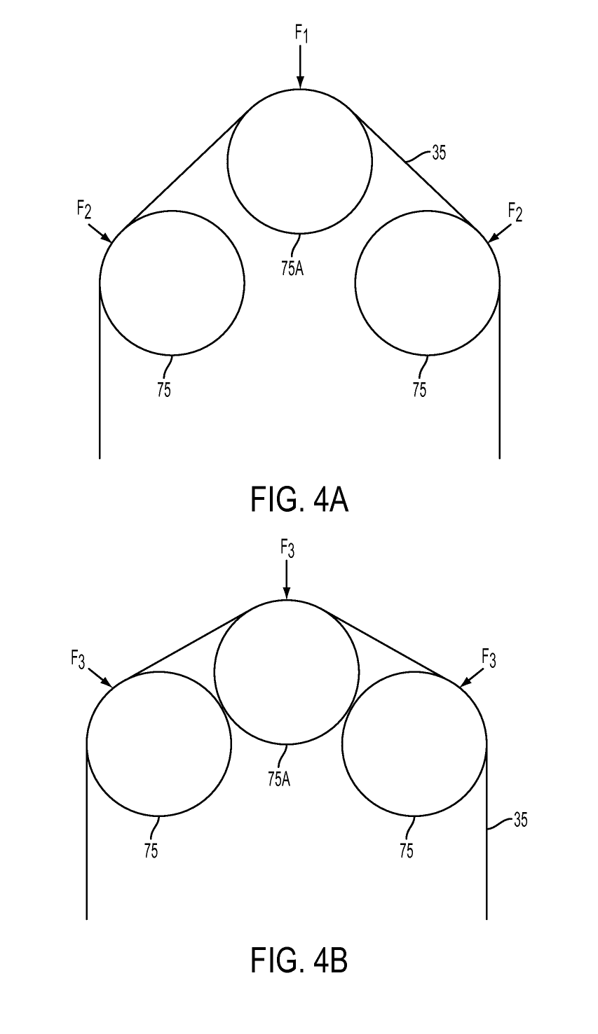

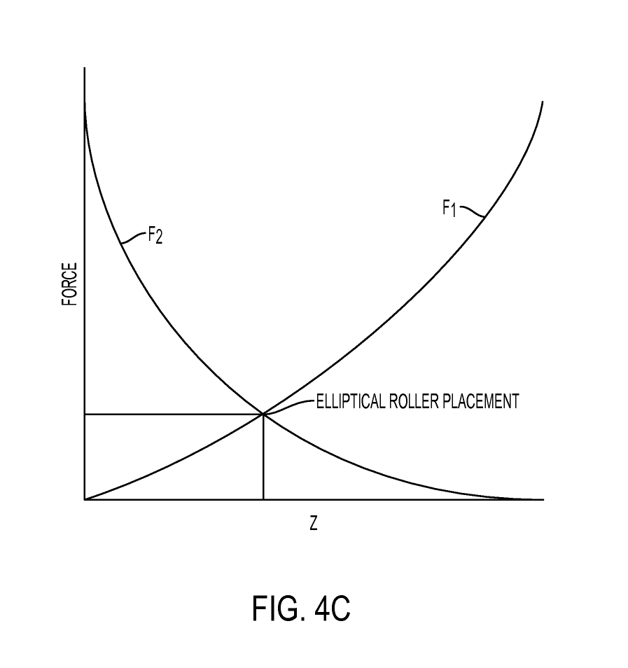

A hypothetical example of how arranging rollers 75 and 75A along an elliptical arc, such as arc 85, instead of a circular arc may reduce stresses in hoses 35 is illustrated in FIG. 4. In arrangement A, rollers 75 and 75A are located along a circular arc. A hose 35 running over the rollers 75 and 75A of arrangement A have a relatively small contact area with rollers 75 and relatively large contact area with roller 75A. Thus, a vertically acting force on hose 35 of arrangement A acts primarily on roller 75A with relatively little of such force acting on rollers 75, as indicated by force arrows F₁ and F₂. A hypothetical plot of F₁ versus F₂ is illustrated in FIG. 4C for a given downward force acting on hose 35. FIG. 4C illustrates a hypothetical example of the height Z of the roller 75A varying above the rollers 75. A plot of F₁ versus F₂ for the circular roller arrangement (FIG. 4A) occurs to the right of the point labeled “Elliptical Roller Placement.”

In contrast, a hose 35 running over the elliptically configured rollers 75 and 75A of arrangement B have a substantially similar contact area with rollers 75 and 75A. A vertically acting force on hose 35 of arrangement B acts relatively equally on each of the rollers 75 and 75A, as indicated by force arrows F₃ (which corresponds to the intersection of F₁ and F₂ illustrated in FIG. 4C). Thus, the elliptical configuration of the rollers 75 and 75A in arrangement B relatively evenly distributes a vertically acting force on hose 35 among all of the rollers whereas the circular configuration of the rollers 75 and 75A in arrangement A substantially concentrates such a vertically acting force on roller 75A. Because the concentrated force F₁ acting on roller 75A of arrangement A is higher than any of the distributed forces F₃ acting on rollers 75 and 75A of arrangement B, a higher stress is induced in the hose 35 of arrangement A which may lead to faster wearing of the hose 35 when compared to the hose 35 of arrangement B.

Another advantage is that arranging hose rollers 75 along an elliptical path provides both a reduced height (in the Z direction of FIG. 3) and an increased width (in the X direction of FIG. 3) for placement of the hoses 35 compared to a similar arrangement of rollers and hoses but arranged along a circular path. The advantages associated with such an elliptical path include an increased mast opening frame size compared to commonly available masts due to the reduced height of hoses 35 and less wear on the hoses 35 due to clearance from the lift chain 67 resulting from the increased width. For example, compare the path of hoses 35 over the hose roller assembly 70 against the path of chains 67 over the circular chain sheave 65.

While the embodiment illustrated in FIGS. 2 and 3 depicts three hose rollers 75 and 75A having a substantially similar diameter, two or more hose rollers 75 or 75A, or other suitable hose rollers, may be used in other embodiments and may have different diameters. For example, a hose roller may be positioned along elliptical path 90 with a longitudinal axis that intersects point 95 and a second hose roller may be positioned along elliptical path 90 with a longitudinal axis that intersects point 100. The two hose rollers may have the same diameter, or may have different diameters, and be positioned such that hydraulic hoses 35 take a desired path, that is, one with a lower height and a greater width when compared against similar hose rollers arranged along a circular path.

In the embodiment illustrated in FIGS. 2 and 3, only the hose rollers 75 include flanges 105, and the two hose rollers 75 are located at the ends of the hose roller assembly 70. Flanges 105 inhibit hoses 35 from moving into contact with the sidewalls 110 of the upper portion 55, thus inhibiting wear caused by contact combined with relative motion between the hoses 35 and the sidewalls 110. Preferably, a radius 107 between the flange 105 and the outer surface of a hose roller 75 matches, or substantially matches, the outer contour of the hoses 35, thus further inhibiting wear between the hose 35 and the hose roller 75. Manufacturing a hose roller 75A without a flange 105 is commonly less expensive than manufacturing a hose roller 75 having a flange 105, thus including one or more hose rollers 75A typically lessens the manufacturing cost of a hose header 50 without significantly impacting the functionality of such a hose header 50. Additionally, including one or more hose rollers 75A permits the collection of rollers to be located closer to each other compared against using only rollers 75, where the flanges 105 would keep the rollers 75 relatively far apart. Thus, for a given edge-to-edge distance X of the outside rollers 75 (see FIG. 3) including one or more hose rollers 75A permits rollers 75 and 75A to have a larger diameter compared against using only rollers 75. The present inventors have realized that providing a larger diameter for a roller 75 or 75A increases hose 35 contact area which decreases point stresses for hoses 35 traversing rollers 75 and 75A and thus may reduce wear of the hoses 35 compared against smaller diameter rollers.

The present inventors recognized that typical rollers provided for hydraulic hoses on a lift tuck mast are only as wide as the aggregate width of the hoses such that the hoses are nested against each other, flanges on the roller, or both. The present inventors have recognized that hoses carried by a typical roller having a width that is only as wide as the aggregate width of the carried hoses may cause hose wear (because the hose wants to take a different track than the one in which it is constrained) and rubbing against either other hoses or a roller flange. Thus, the hose rollers 75 and 75A are optionally wider than the aggregate width of all of the hydraulic hoses 35 carried by the hose roller assembly 70. The present inventors recognized that providing such wide hose rollers 75 and 75A permits each hydraulic hose 35 to find its own natural track, that is, the path each hose 35 wants to take under the influence of hose tension, positioning of the hose ends, mast bend, and other suitable factors, preferably without scrubbing against flanges, sidewalls or other hoses 35.

The present inventors also recognized that such factors may change, and thus the natural track for hoses 35 may change. For example, because hydraulic cylinder 40 is commonly installed in a less than perfect vertical alignment, as the cylinder 40 extends and retracts it applies different lateral forces (that is, along the longitudinal axis 80) on the hoses 35 which may cause the hoses 35 to move to a new track.

The present inventors also recognized that providing such wide hose rollers 75 and 75A permits hoses 35 to naturally flatten as they traverse the hose rollers 75 and 75A, thus inhibiting wear on the hoses 35 due to the forces that cause flattening pushing the hoses into the flanges or other hoses, such as may occur when commonly available narrow rollers are used.

The present inventors have thus recognized that providing hose rollers 75 and 75A that are wider than the aggregate width of the hoses 35 may reduce stress and wear on the hoses 35, thus prolonging their useful life.

Optionally, the distance between the bottom 115 of sidewalls 110 and the top 120 of lower portion 60 is adjustable, for example, to adjust tension on hoses 35 as they age and stretch, to account for installation of new hoses 35, or for other suitable reasons. An adjustable fastener, such as fastener 125, is preferably used to position and hold the upper portion 55 a selected vertical distance from the lower portion 60. Such a selected vertical distance may be one of a series of predetermined distances, or may be any distance within a range of distances.

Fastener 125 comprises an optional guide and a positioning device. The optional guide comprises four slots 130 and a peg 135 that extends through each slot 130. Pegs 135 are preferably sized and dimensioned to fit within slots 130 such that movement of the upper portion 55 is substantially constrained to linear movement, preferably in a vertical direction with respect to lower portion 60. Pegs 135 may be threaded into the lower portion 60, welded in place, or otherwise suitably secured to the lower portion 60. In other embodiments, slots may be formed in the lower portion 60 and pegs may be secured to the upper portion 55.

The positioning device comprises a series of adjustment apertures 140, two holding apertures 145, and a pin 150. In the embodiment illustrated in FIGS. 2 and 3, the adjustment apertures 140 are arranged in two substantially parallel lines where each adjustment aperture 140 is vertically off-set from its neighboring adjustment apertures 140. Such staggering of the adjustment apertures 140 provides a finer vertical height adjustment increment because the centers of the adjustment apertures 140 are vertically closer than would be possible if only a linear series of adjustment apertures 140 were provided. However, in other embodiments, adjustment apertures may be provided in a single linear arrangement, or in any other suitable arrangement.

Holding apertures 145 are horizontally aligned, one with each row of the adjustment apertures 140, and are vertically aligned with each other. Optionally, the diameter of the holding apertures 145 is smaller than the diameter of the adjustment apertures 140 such that an adequately sized land, or space, between the edges of the holding apertures 145 exists.

Pin 150 releasably engages the holding apertures 145, and depending on the height a user desires to set between the bottom 115 of sidewalls 110 and the top 120 of lower portion 60, is passed through one of the adjustment apertures 140 and into one of the holding apertures 145. By providing a like arrangement of adjustment apertures 140 and holding apertures 145 on both sides of the hose header 50 a user may adjust the upper portion 55 to a desired height and ensure that the upper portion 55 is level by placing the pin 150 through the similarly positioned adjustment aperture 140 and holding aperture 145 on each side of the hose header 50. The pin 150 may be secured into a holding aperture 145 via threads, a quick release mechanism, or other suitable device. If the holding apertures 145 have a smaller diameter than the adjustment apertures 140, the pin 150 preferably has a larger diameter portion that coincides with the adjustment apertures 140 and a smaller diameter portion that extends from the back of the adjustment apertures 140 and into the holding apertures 145 when the pin 150 is secured into a holding aperture 145. In other embodiments, adjustment apertures may be formed in the lower portion 60 and holding apertures may be formed in the upper portion 55.

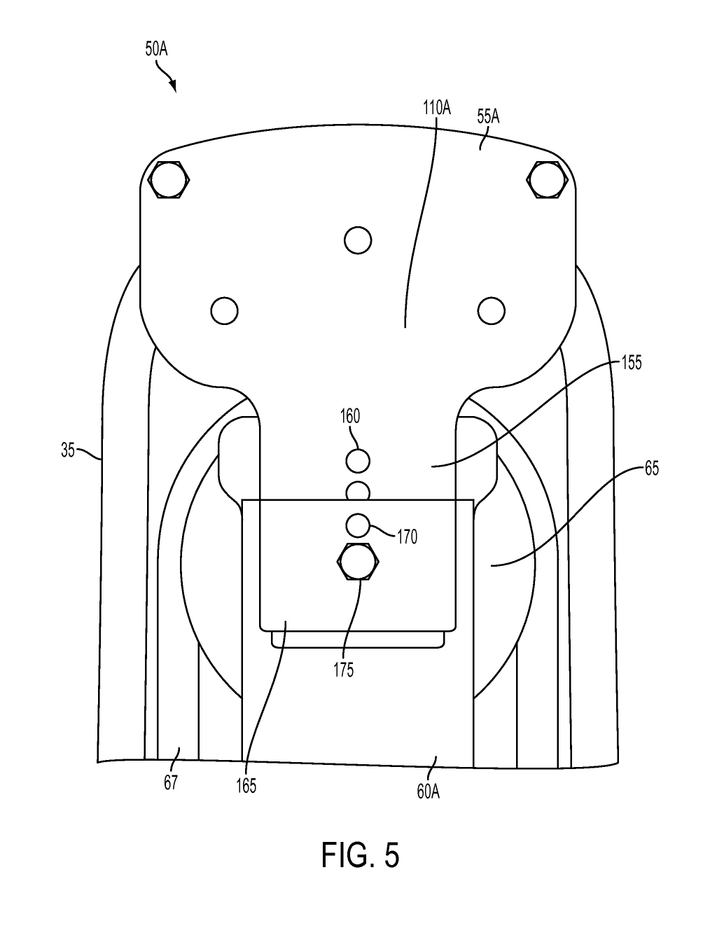

Other suitable fasteners may be used, and may include guides and positioning devices that are integrated. For example, a fastener may include a post 155 (FIG. 5) depending from sidewall 110A with either one or a series of apertures 160 through the post 155. A sleeve 165 may be secured to the lower portion 60A to receive the post 155 and the sleeve 165 may include one or a series of apertures 170. A pin or key 175 may be inserted through the apertures 160 and 170 to hold the upper portion 55A at a selected height above the lower portion 60A.

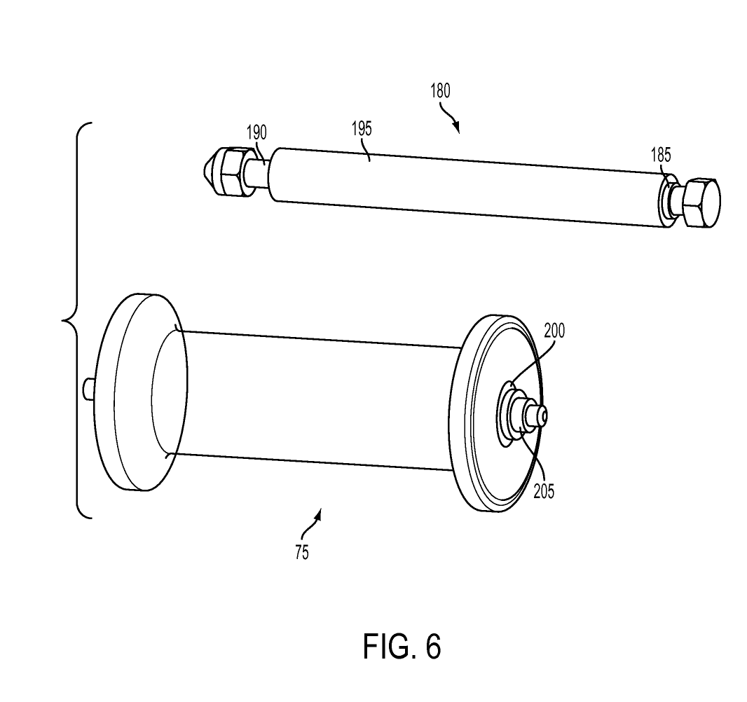

An optional hose guard 180 may be provided to inhibit the hoses 35 from coming off of the hose roller assembly 70. Preferably, two hose guards 180 are attached to the upper portion 55 and may provide structural rigidity for the upper portion 55. In the embodiment illustrated in FIGS. 2 and 3, the hose guards 180 comprise a compression tube 185 (FIG. 6) that is held in place by a bolt 190. A guard roller 195 is retained over the compression tube 185 such that the guard roller 195 is free to rotate about the compression tube 185 when the bolt 190 is tightened. By providing a guard roller 195 that is free to rotate, contact of a hose 35 against a static guard is inhibited. In other words, if a hose 35 is moving over the hose roller assembly 70 and is caused to come into contact with the guard roller 195, the guard roller 195 should roll because of the force exerted by the hose 35, thus inhibiting rubbing (and thus wear) between the hose 35 and the guard roller 195.

The present inventors recognized that typical rollers include bushings that have a relatively high resistance to rolling because a static friction between the bushings and the inserts acting as axles needs to be overcome to initiate rolling. Thus, the hose rollers 75 and 75A may include optional sealed ball bearing assemblies 200 (FIG. 6) secured to each end to reduce the rolling resistance of hose rollers 75 and 75A compared against commonly available rollers. Inclusion of ball bearing assemblies 200 may also permit a limited amount of movement of the hose rollers 75 and 75A along the longitudinal axis 80, which may facilitate hoses 35 to better track over the hose rollers 75 and 75A.

Another optional item that may be included on the hose rollers 75 and 75A is a spacer 205 (FIG. 6) that reduces the potential contact area between the sidewalls 110 (FIG. 2) and the hose rollers 75 and 75A, compared against not including the optional spacer 205, to further inhibit rolling resistance.

The foregoing is a detailed description of illustrative embodiments of the invention using specific terms and expressions. Various modifications and additions can be made without departing from the spirit and scope thereof. Therefore, the invention is not limited by the above terms and expressions, and the invention is not limited to the exact construction and operation shown and described. On the contrary, many variations and embodiments are possible and fall within the scope of the invention which is defined only by the claims that follow.

1. A mast for a lift truck comprising:
a first upright;
a second upright spaced from the first upright to form a rail;
a hose header comprising a first portion, a second portion and a fastener connecting the first portion to the second portion; and
wherein the fastener comprises a positioning device configured to releasably hold the first portion at selectable distances from the second portion.

2. A mast according to claim 1, wherein the fastener further comprises a guide configured to direct the first portion along a linear path with respect to the second portion.

3. A mast according to claim 2, wherein the guide comprises a plurality of substantially parallel slots formed in the first portion of the hose header and a peg protruding through each slot.

4. A mast according to claim 1, wherein the positioning device comprises:
a plurality of adjustment apertures formed through one of the first or second portions;
a holding aperture formed through the other of the first or second portions; and
a pin configured to extend into an aligned holding aperture and adjustment aperture to releasably secure the first portion in place with respect to the second portion;
wherein the first portion is configured to move with respect to the second portion for selectably aligning the holding aperture with an adjustment aperture.

5. A mast according to claim 4 wherein the adjustment apertures comprise two substantially parallel off-set rows of apertures and the holding aperture comprises two apertures that are substantially in the same horizontal plane.

6. A mast according to claim 1, wherein the hose header further comprises a hose roller assembly secured to the first portion, the hose roller assembly comprising a plurality of hose rollers that each have a central longitudinal axis that intersects a point on an elliptical arc.

7. A mast according to claim 6, wherein a width of the hose roller assembly is wider than an aggregate width of hoses supported by the hose roller assembly.

8. A mast for a lift truck comprising:
a first upright;
a second upright spaced from the first upright to form a rail;
a hose header positioned between the first and second uprights;
wherein the hose header comprises an upper portion and a lower portion;
wherein the upper portion is moveable along a vertical direction with respect to the lower portion; and
wherein a height adjustment mechanism engages the upper portion and the lower portion such that the height adjustment mechanism is configured to releasably secure the upper portion at various distances from the lower portion.

9. A mast according to claim 8, wherein the height adjustment mechanism comprises:
a plurality of substantially parallel slots formed in the first portion of the hose header and a peg protruding through each slot;
a plurality of adjustment apertures formed through one of the upper or lower portions;
a holding aperture formed through the other of the upper or lower portions;
wherein the upper portion is configured to move with respect to the lower portion and selectably align the holding aperture with an adjustment aperture; and
a pin configured to extend into an aligned holding aperture and adjustment aperture to releasably secure the upper portion in place with respect to the lower portion.

10. A mast according to claim 9 wherein the adjustment apertures comprise two substantially parallel off-set rows of apertures and the holding aperture comprises two apertures that are substantially in the same horizontal plane.

11. A mast for a lift truck comprising:
a first upright;
a second upright spaced from the first upright to form a rail;
a hose header positioned between the first and second uprights;
wherein the hose header comprises a hose roller assembly secured to the first portion, the hose roller assembly comprising a plurality of hose rollers that each have a central longitudinal axis that intersects a point on an elliptical arc.

12. A mast according to claim 11, wherein the hose roller assembly comprises three hose rollers.

13. A mast according to claim 11, wherein the hose roller assembly includes two end hose rollers and only the two end hose rollers have flanges to inhibit hoses from moving off of the hose roller assembly.

14. A mast according to claim 11, wherein a width of the hose roller assembly is wider than an aggregate width of hoses supported by the hose roller assembly.

15. A mast according to claim 11, further comprising a sealed ball bearing race secured to each end of each hose roller to facilitate rolling motion for each hose roller such that relative motion between each hose roller and hoses carried thereby is inhibited.

16. A mast according to claim 15, further comprising a spacer secured to each end of each hose roller, wherein each spacer is configured such that relative motion between each hose roller and hoses carried thereby is further inhibited.

17. A mast according to claim 11, further comprising a hose guard attached to the first portion, wherein the hose guard comprises a compression tube bearing a guard roller.
